(19) United States
(12) Patent Application Publication
(10) Pub. No.: US 2007/0137266 A1
(43) Pub. Date: Jun. 21, 2007

(54) Trailer lock

(75) Inventor: Chin-Hui Hsai, Chang Hua (TW)

Correspondence Address: BRUCE H. TROXELL;SUITE 1404, 5205 LEESBURG PIKE, FALLS CHURCH, VA, 22041, US

(73) Assignee: Handyway Co., Ltd.

(21) Appl. No.: 11/304,741

(22) Filed: Dec. 16, 2005

(51) Int. Cl. E05B 67/36; E05B 25/00

(52) U.S. Cl. 70/34; 70/386

(57) ABSTRACT

A trailer lock has a lock body which includes a cylinder and a core with a torsional spring interposed between them. The core has one end inserting into the cylinder and another end coupling with steel balls and a return spring and a movable plug. The cylinder and an anchor shell are latched in an interlocked manner to encase the core and the movable plug to prevent the steel balls from escaping. The elements thus formed can be rapidly assembled and installed in an outer casing.

### BACKGROUND OF THE INVENTION

1. Field of the Invention

The present invention relates to a trailer lock and particularly to a trailer lock that has an improved lock body to facilitate installation.

2. Description of the Prior Art

Locks are known in the prior art in a wide variety of forms. Reference can be found in R.O.C. patent publication No. 268505 entitled “Locks for bicycles and motorcycles”, R.O.C. patent publication No. 339749 entitled “Automatic bouncing steel cable lock”, and R.O.C. patent publication No. 382384 entitled “Improved pin lock”. While they offer some improvements for locks, they do not provide automatic return and bouncing functions. They also adopt a complicated design and contain too many elements. As a result, the cost is higher and installation is difficult. Due to the steel balls are compressed by a spring, they easily scatter out before being installed in the lock body. This often causes a lot of trouble during installation.

### SUMMARY OF THE INVENTION

In view of the aforesaid problems, the primary object of the present invention is to provide a trailer lock with a lock body installable easily and quickly without dropping steel balls.

The invention mainly includes a lock body which consists of a cylinder, a core, a movable plug, an anchor shell and an outer casing. The cylinder has a through hole in the center, a plurality of axial flutes formed on the inner wall of the through hole from one end thereof, a bucking hole of a smaller diameter on another end of the through hole, and a plurality of anchor troughs formed on the one end from an outer surface to engage with one end of a torsional spring. The core is cylindrical and held in the cylinder, and has, in this order from one end thereof, a head, a shoulder adjacent to the head, a shank with an outer diameter smaller than the head and a keyway end with an outer diameter smaller than the shank. The head has an indented holding trough with at least two opposing troughs formed on an inner side and cavities on an outer side to hold steel balls. The shoulder and the cylinder are engaged with another end of the torsional spring. The shank has elastic and extendable juxtaposed blades corresponding to the flutes. The keyway end has a keyway to receive a key to drive the juxtaposed blades. The shank is housed in the through hole with the keyway end exposed to the bucking hole. The movable plug is located in the core and has one end pressing a return spring, and insertion ribs on an outer side corresponding to the opposing troughs. The movable plug and the return spring are held in the holding trough of the core. The anchor shell is hollow to encase the movable plug and the core, and has an outer diameter corresponding to the cylinder and a center hole in the hollow center, and two corresponding steel ball outlets formed on a side wall on one end. The periphery of the side wall adjacent to the steel ball outlets has two arched steel ball holding troughs formed thereon. The anchor shell further has opposing axial lugs on another end opposite to the steel ball outlets mating the anchor troughs of the cylinder in an interlocked manner. The lugs oppose the steel ball outlets axially such that the steel balls are located vertically to the lugs. The outer casing aims to house all the aforesaid elements and has an opening on one end, and a housing chamber adjacent to the opening with a hole on another end opposing the opening. The anchor shell, cylinder and contained elements are held in the housing chamber through the opening. The insertion ribs of the movable plug are stopped by an inner end surface where the hole is formed. The outer casing is fastened to the side wall of the cylinder.

The bucking hole formed on the another end of the through hole of the cylinder has a smaller diameter. The bucking hole has a sliding groove on an inner side. The keyway end of the core has an outer diameter smaller than the shank and a flange extended from the outer side to slide in the sliding groove.

The outer casing further has an aperture to allow a pin to be inserted into the side wall of the cylinder to fasten the cylinder to the outer casing.

A latch bar is provided and insertable in the lock body. The latch bar has an annular groove on one end to be latched by the steel balls.

By means of the construction set forth above, the invention can provide the following advantages:

1. The core is formed in an integrated body, hence can be assembled and installed easily. It contains simpler elements.

2. The invention provides an automatic bouncing effect. Through the design of the steel balls and movable plug, when a key is inserted and turns the core, the latch bar is pushed out by the movable plug. Unlocking can be done quickly, and an automatic bouncing effect is generated. The key may be removed or not removed during unlocking.

3. The anchor shell and the cylinder of the invention are latched correspondingly, and fully encase the movable plug, steel balls and core. Hence the steel balls are covered by the steel balls holding trough of the anchor shell before being installed in the outer casing and do not escape. Therefore the problem of dropping the steel balls due to bouncing of the elastic force occurred to the conventional techniques can be avoided. Installation is easy and can be done quickly. It is more convenient.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2 is an exploded view of the lock body and the outer casing before assembly.

FIG. 3 is a perspective view of the invention adopted for use as a trailer lock.

FIG. 4 is a sectional view of the invention in the axial direction after assembled.

FIG. 5 is a sectional view of the invention in the radial direction after assembled.

FIG. 6 is a sectional view of the invention in the axial direction with the latch bar in a latched condition.

FIG. 7 is a sectional view of the invention in the radial direction according to FIG. 6.

FIG. 8 is a sectional view of the invention at the keyway end in the radial direction.

### DESCRIPTION OF THE PREFERRED EMBODIMENTS

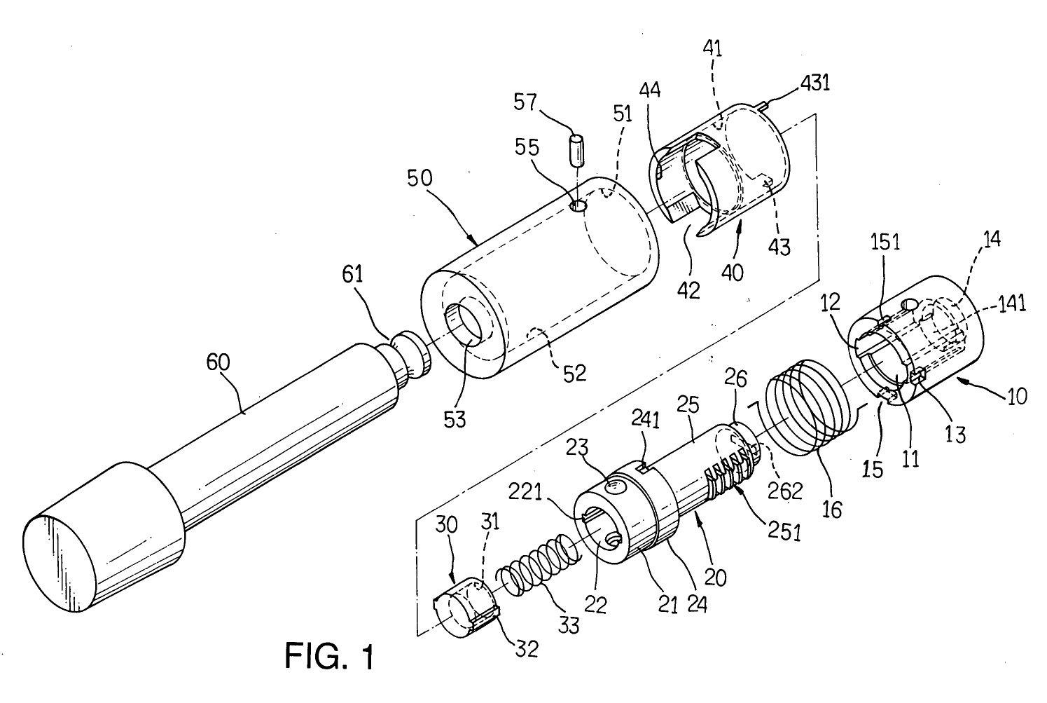

Referring to FIGS. 1, 2 and 4, the trailer lock according to the invention has a lock body to couple with a latch bar 60 to form a locking and a unlocking condition. The lock body includes:

a cylinder 10 which has a through hole 11 in the center, a plurality of axial flutes 12 formed on an inner wall of the through hole from one end thereof, a bucking hole 14 of a smaller diameter on another end of the through hole, and a plurality of anchor troughs 15 and 151 and a first insertion trough 13 formed on one end from an outer surface. The first insertion trough 13 is engaged with one end of a torsional spring 16. The bucking hole 14 has a sliding groove 141 on an inner side;

a cylindrical core 20 which is located in the cylinder 10 and has, in this order from one end thereof, a head 21, a shoulder 24 adjacent to the head with a greater outer diameter than the head, a shank 25 with an outer diameter smaller than the head 21 and a keyway end 26 with an outer diameter smaller than the shank 25. The head 21 has an indented holding trough 22 with at least two opposing troughs 221 formed on an inner side and cavities on an outer side to hold steel balls 23. The shoulder 24 has a second insertion trough 241 from one end. The first and second insertion troughs 13 and 241 are engaged with two ends of the torsional spring 16. The shank 25 has two rows of elastic and extendable juxtaposed blades 251. While one row retracts, the other row extends. The keyway end 26 has a keyway 262 to receive a key to drive the juxtaposed blades 251 to extend and retract. The keyway end 26 further has a flange 261 extending outwards to be wedged in the sliding groove 141. By aligning the juxtaposed blades 251 with the flutes 12, the shank 25 may be inserted into the through hole 11 with the keyway end 26 held in the bucking hole 14 and exposed;

a movable plug 30 which is located in the core 20, and has a recess 31 to hold a return spring 33, and jutting insertion ribs 32 on an outer side corresponding to the opposing troughs 221. The movable plug 30 and the return spring 33 are held together in the holding trough 22 of the core 20;

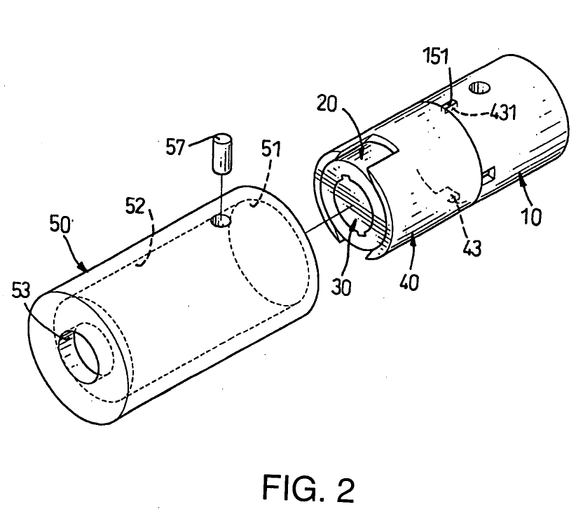

an anchor shell 40 which is hollow to encase the movable plug 30 and the core 20, and has an outer diameter corresponding to the cylinder 10, and a center hole 41 in the hollow portion. It also has steel ball outlets 42 on the side wall of one end corresponding to the steel balls 23. The periphery of side wall adjacent to the steel ball outlets 42 forms two arched steel ball holding troughs 44. The anchor shell 40 has another end with lugs 43 and 431 formed thereon axially to mate the anchor troughs 15 and 151 of the core 10 in an interlocked manner. The lugs 43 and 431 oppose the steel ball outlets 42 axially such that the steel balls 23 are located vertically to the lugs 43 and 431. Thereby when the anchor shell 40 is coupled with the movable plug 30, the lugs 43 and 431 are inserted into the anchor troughs 15 and 151, thereby the steel ball outlets 42 are offset from the steel balls 23, and the steel ball holding troughs 44 of the anchor shell 40 block the steel balls 23 from dropping as shown in FIG. 2;

an outer casing 50 which holds the aforesaid elements. It has an opening 51 on one end, a housing chamber 52 adjacent to the opening 51, and a hole 53 on another end opposing the opening 51. The anchor shell 40, cylinder 10 and elements located therein are held in the housing chamber 52 through the opening 51. The insertion ribs 32 of the movable plug 30 are stopped by an inner end surface where the hole 53 is formed. The outer casing 50 is fastened to the side wall of the cylinder 10 by inserting a pin 57 in the cylinder 10 through an aperture 55 formed on the outer casing 50. As the cylinder 10 and the anchor shell 40 are anchored by coupling of the anchor troughs 15 and 151 and the lugs 43 and 431 in an interlocked manner, they do not rotate with the core 20; and

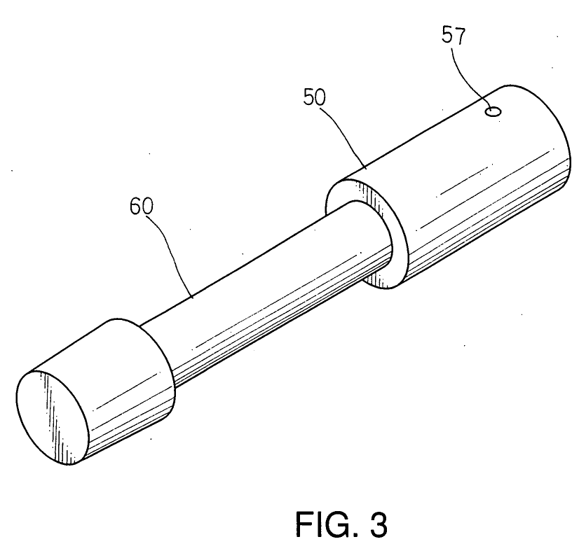

a latch bar 60 which is latched in the core 20. It has an annular groove 61 on one end mating the steel balls 23 to be coupled therewith as shown in FIG. 3. The assembly thus formed becomes the trailer lock of the invention.

When the invention is in use, first, turn the core 20 to move the steel balls 23 to the steel ball outlets 42 (referring to FIGS. 1, 4 and 5); as the latch bar 60 is not yet inserted into the lock body, the steel balls 23 are held in the steel ball outlets 42 and covered by the outer casing 50, and located on the periphery of the movable plug 30; the insertion ribs 32 of the movable plug 30 are stopped by the inner end surface of the hole 53 without escaping; the juxtaposed blades 251 are separated from the flutes 12.

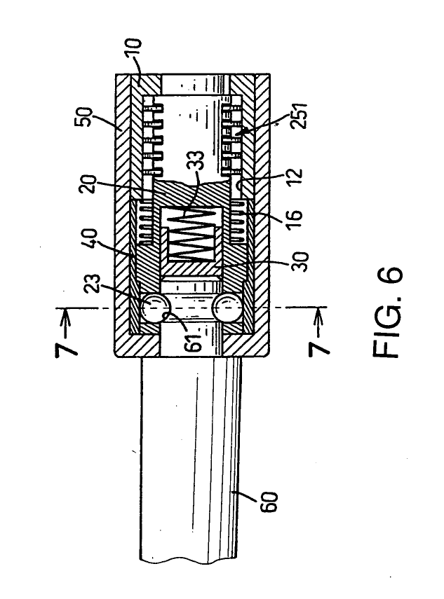

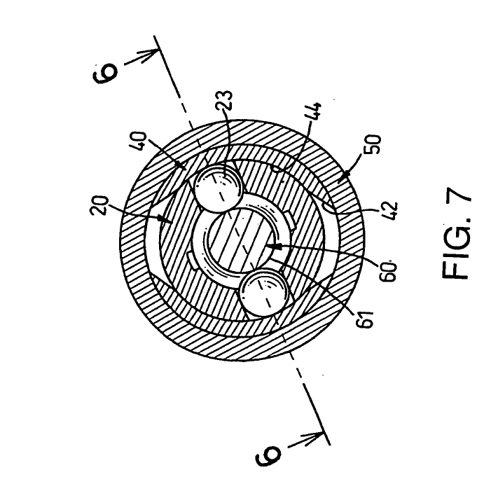

To latch the latch bar 60 on the lock body, referring to FIGS. 1, 6 and 7, insert the latch bar 60 into the hole 53 to push the movable plug 30; the return spring 33 is compressed, and the insertion ribs 32 are moved axially along the opposing troughs 221 to retract the movable plug 30; the steel balls 23 are not retained by the movable plug 30, the torsional force of the torsional spring 16 urge the steel balls 23 to the steel ball holding troughs 44 to be extended inwards; with the latch bar 60 inserted and held in the holding trough 22 of the core 20, the steel balls 23 wedge in the annular groove 61 of the latch bar 60, and the juxtaposed blades 251 enter the flutes 12; a locking condition is established.

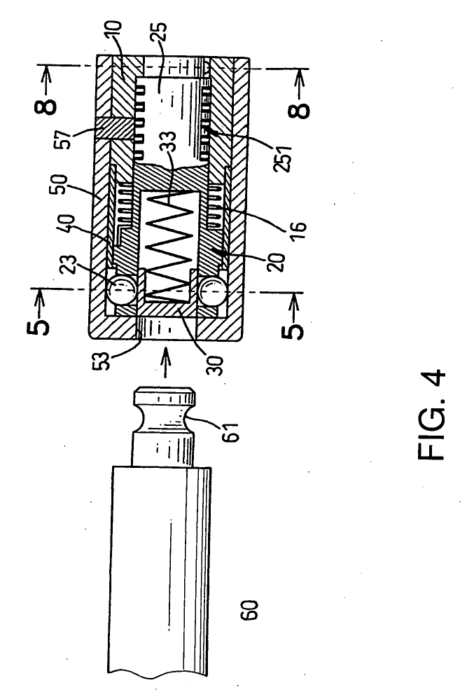

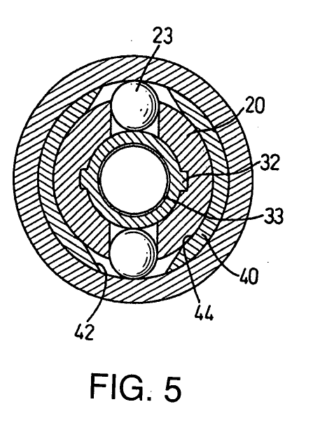

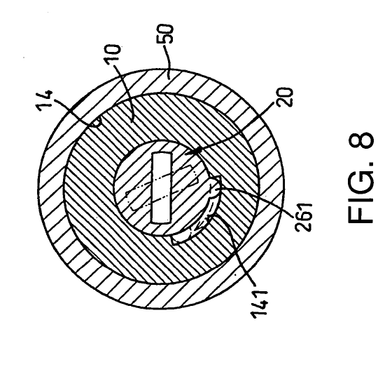

For unlocking, insert a key (not shown in the drawings) into the keyway 262 of the keyway end 26; turn the key to overcome the torsional force of the torsional spring 16; as shown in FIG. 8, the flange 261 slides along the sliding groove 141 to restrict the turning displacement of the core 20; the steel balls 23 are driven to turn with the core 20, and moved from the steel ball holding troughs 44 to the steel ball outlets 42; the restoring elastic force of the return spring 33 pushes the movable plug 30 to move the steel balls 23 outwards; the movable plug 30 is pushed by the return spring 33 to automatically push the latch bar 60 outside as shown in FIGS. 4 and 5.

In summary, the invention has the anchor shell 40 and cylinder 10 encasing two ends of the movable plug 30 and the core 20 to prevent the steel balls 23 from escaping. The entire set is housed in the outer casing 50. Installation is simple.

1-4. (canceled)

5. A trailer lock comprising:
a lock body having:
a) a cylinder having:
I) a through hole located in a center of a first cylinder end thereof;
ii) a plurality of axial flutes formed on an inner wall of the through hole;
iii) a bucking hole located in a center of a second cylinder end thereof and communicating with the through hole, the bucking hole having a diameter smaller than a diameter of the through hole;
iv) a plurality of anchor troughs located on the first cylinder end; and
v) a first insertion trough located on the first cylinder end;
b) a cylindrical core movable between locked and unlocked positions and having:
I) a head located on a first core end and having an indented holding trough having at least two troughs equally spaced apart along an inner wall thereof and a plurality of cavities located through a peripheral wall of the head, one of a plurality of steel balls is located in each of the plurality of cavities;
ii) a shoulder located adjacent to the head and having a second insertion trough;
iii) a keyway end located on a second core end; and
iv) a shank located between the shoulder and the keyway end and having elastic and extendable juxtaposed blades selectively inserted into the plurality of axial flutes, the shank having an outer diameter smaller than an outer diameter of the head, the keyway end having an outer diameter smaller than an outer diameter of the shank, the keyway end having a keyway receiving a key for driving the juxtaposed blades, the shank is inserted into the through hole of the cylinder, the keyway end is inserted into the bucking hole;
c) a torsional spring located around the shank and having a first end inserted into the first insertion trough and a second end inserted into the second insertion trough;
d) a movable plug slidably inserted into an interior of the indented holding trough of the cylindrical core and having at least two jutting insertion ribs protruding outwardly from and exterior thereof, one of the at least two jutting insertion ribs is inserted into each of the at least two troughs of the indented holding trough;
e) a return spring located between an end of the movable plug and the indented holding trough;
f) an anchor shell having:
I) a center hole, the cylindrical core and the movable plug are located in the center hole of the anchor shell;
ii) two steel ball outlets located on a first shell end thereof and corresponding with the plurality of steel balls;
iii) two arched steel ball holding troughs formed in an inner wall of of the center hole, one of the two arched steel ball holding troughs is located adjacent to each the two steel ball outlets; and
iv) a plurality of lugs located on a second shell end thereof, one of the plurality of lugs is inserted into each of the plurality of axial flutes; and
g) an outer casing connected to the cylinder and having:
I) a housing chamber located in an interior thereof;
ii) an outer casing opening located on a first casing end thereof and communicating with the housing chamber; and
iii) an outer casing hole located on a second casing end thereof and communicating with the housing chamber, the anchor shell, the cylindrical core, the movable plug, and the cylinder are inserted into the housing chamber, the movable plug being located adjacent to and retained in the housing chamber by the outer casing hole,
wherein, when the cylindrical core is located in the locked position, the plurality of steel balls are located in the two arched steel ball holding troughs, and, when the cylindrical core is located in the unlocked position, the plurality of steel balls are located in the two steel ball outlets.

6. The trailer lock according to claim 5, wherein the bucking hole has a slide groove, the keyway end has a flange extending outwardly and slidably inserted into the slide groove.

7. The trailer lock according to claim 5, further comprising a pin, the outer casing has an aperture, the pin is inserted into the aperture.

8. The trailer lock according to claim 5, further comprising a latch bar selectively inserted into the lock body and having an annular groove, the plurality of steel balls are selectively inserted into the annular groove.

9. The trailer lock according to claim 5, wherein the movable plug has a recess, an end of the return spring is inserted into the recess.

10. The trailer lock according to claim 5, wherein a distance between outer ends of the at least two jutting insertion ribs is larger than a diameter of the outer casing hole.

11. The trailer lock according to claim 5, wherein the outer casing hole has a diameter smaller than a diameter of the outer casing opening.
